(19) United States
(12) Patent Application Publication
(10) Pub. No.: US 2017/0218635 A1
(43) Pub. Date: Aug. 3, 2017

(54) STUCCO SUPPORT STRUCTURES AND STUCCO WALLS

(71) Applicant: Owens Corning Intellectual Capital, LLC, Toledo, OH (US)

(72) Inventors: Robert J. O'Leary, Newark, OH (US); James Rinne, Granville, OH (US); Anthony L. Rockwell, Pickerington, OH (US); Timothy R. Clancy, Swanton, OH (US); Agustin Hernandez, Perrysburg, OH (US); Lamar Kenneth Anderson, Perrysburg, OH (US); Leonard Joseph Adzima, Pickerington, OH (US)

(21) Appl. No.: 15/419,648

(22) Filed: Jan. 30, 2017

Related U.S. Application Data
(60) Provisional application No. 62/289,412, filed on Feb. 1, 2016.

(51) Int. Cl. E04F 13/04; B32B 5/02; B32B 3/30; B32B 7/12; B32B 27/06; E04C 2/26; B32B 5/18

(52) U.S. Cl. CPC E04F 13/04; E04F 13/047; E04C 2/26; B32B 5/022; B32B 5/18; B32B 5/024; B32B 5/028; B32B 7/12; B32B 27/06; B32B 3/30; B32B 2607/00

(57) ABSTRACT

Stucco support structures and stucco wall systems incorporating the stucco support structures are provided. The stucco support structure includes a structural layer of composite material. The composite material includes a homogenous matrix of a gypsum material and a polymer resin material, and wet-use chopped strand fibers that are filamentized within the homogenous matrix. The stucco support structure also includes a stucco adhesion member interfaced with the structural layer that is configured to receive and bond a stucco material to the structural layer. The stucco support structure eliminates the need for sheathing and wire mesh lath conventionally used in stucco applications.

### CROSS-REFERENCE TO RELATED APPLICATIONS

The present application claims priority to and any other benefit of U.S. Provisional Patent Application No. 62/289,412, titled “Stucco Support Structures and Stucco Walls,” filed on Feb. 1, 2016, the entire disclosure of which is incorporated herein by reference in its entirety.

### FIELD

The present invention relates generally to stucco walls and, more particularly, to a polymer and gypsum composite support structure for stucco walls.

### BACKGROUND

Interior and exterior construction boards, panels and surfaces with cores of plaster, cement, or hybrid materials, such as cement boards or gypsum boards, are used in a wide variety of indoor and outdoor structural applications. For example, the cement boards are used as a support surface for overlying materials such as wood siding, stucco, aluminum, brick, tile, stone aggregate, and marble. Also cement and gypsum aggregates, themselves, are used to form interior finishes such as solid surface countertops and fireplace surrounds. Additionally, the cement boards are used in exterior insulating systems, commercial roof deck systems, masonry applications, and exterior curtain walls.

Stucco is a material made of an aggregate, a binder, and water. Stucco is applied wet and hardens to a dense solid. It is used as decorative coating for walls and ceilings. Stucco may be used to cover less visually appealing construction materials such as plywood sheathing, metal, concrete, cinder block, and adobe. Modern stucco is used as an exterior wall covering. It is usually a mix of sand, Portland cement, lime, and water, but may also consist of a proprietary mix of additives including fibers that add strength and flexibility.

### SUMMARY

The present disclosure relates to and contemplates structures for supporting a stucco material and systems for forming a stucco wall. By way of example to illustrate various aspects of the general inventive concepts, several exemplary embodiments of structures for supporting a stucco material and systems for forming a stucco wall are disclosed herein.

In one exemplary embodiment, a structure for supporting a stucco material is provided. The structure comprises a structural layer of composite material. The composite material comprises a) a homogenous matrix of a gypsum material and a polymer resin material; and b) wet-use chopped strand fibers, wherein the wet-use chopped strand fibers are substantially filamentized within the homogenous matrix. The structure also comprises a stucco adhesion member interfaced with the structural layer.

In one exemplary embodiment, a system for forming a stucco wall on a plurality of frame members is provided. The system comprises a stucco support structure attached to the frame members. The stucco support structure comprises a structural layer of composite material. The composite material comprises a) a homogenous matrix of a gypsum material and a polymer resin material; and b) wet-use chopped strand fibers, wherein the wet-use chopped strand fibers are substantially filamentized within the homogenous matrix. The stucco support structure also comprises a stucco adhesion member interfaced with the structural layer. The system also includes at least one stucco coat applied to the stucco adhesion member. The stucco support structure eliminates the need for a sheathing and a wire mesh lath.

In one exemplary embodiment, a system for forming a stucco wall on a plurality of frame members is provided. The system comprises a substrate attached to the frame members, the substrate having an interior facing surface and an exterior facing surface. The system also comprises an entangled net material that extends from the exterior facing surface of the substrate. The system also includes at least one stucco coat on the entangled net material. The at least one stucco coat is applied on the entangled net material such that the stucco coat partially extends through a portion of a thickness of the entangled net material to define a compliance zone. The compliance zone comprises the entangled net material that extends from the exterior facing surface of the substrate and is free of the at least one stucco coat. The compliance zone absorbs forces to reduce or prevent cracking of the at least one stucco coat.

### BRIEF DESCRIPTION OF THE DRAWINGS

FIG. 1 illustrates an example of stucco applied to an external wall of a building;

FIG. 2 illustrates another example of stucco applied to an external wall of a building;

FIG. 3 is a sectional view of an exemplary embodiment of a stucco support structure;

FIG. 4 is a sectional view of an exemplary embodiment of a stucco support structure;

FIG. 5 is a sectional view of an exemplary embodiment of a stucco support structure;

FIG. 6 is a sectional view of an exemplary embodiment of a stucco support structure;

FIG. 7 is a sectional view of an exemplary embodiment of a stucco support structure;

FIG. 8 is a sectional view of an exemplary embodiment of a stucco support structure;

FIG. 9 is a sectional view of an exemplary embodiment of a stucco support structure;

FIG. 9A is a sectional view of an exemplary embodiment of a porous stucco support structure;

FIG. 10 is a sectional view of an exemplary embodiment of a stucco support structure;

FIG. 11 is a sectional view of an exemplary embodiment of a stucco support structure;

FIG. 12 is a sectional view of an exemplary embodiment of a stucco support structure;

FIG. 13 is a sectional view of an exemplary embodiment of a stucco wall that includes a stucco support structure;

FIG. 14 is a sectional view of an exemplary embodiment of a stucco wall that includes a stucco support structure and a foam panel;

FIG. 14A is a sectional view of an exemplary embodiment of a stucco wall that includes a stucco support structure and a foam panel with a drainage plane;

FIG. 14B is a sectional view of an exemplary embodiment of a stucco wall that includes a stucco support structure and a foam panel with a drainage plane;

FIG. 15 is a sectional view of an exemplary embodiment of a stucco support structure;

FIG. 16 is a sectional view of an exemplary embodiment of a stucco support structure;

FIG. 17 is a sectional view of an exemplary embodiment of a stucco wall that includes a stucco support structure of FIGS. 15 and 16;

FIG. 18 is a sectional view of an exemplary embodiment of a stucco wall that includes a stucco support structure of FIGS. 15 and 16; and

FIG. 19 is a sectional view of an alternative exemplary embodiment of a stucco wall.

### DETAILED DESCRIPTION

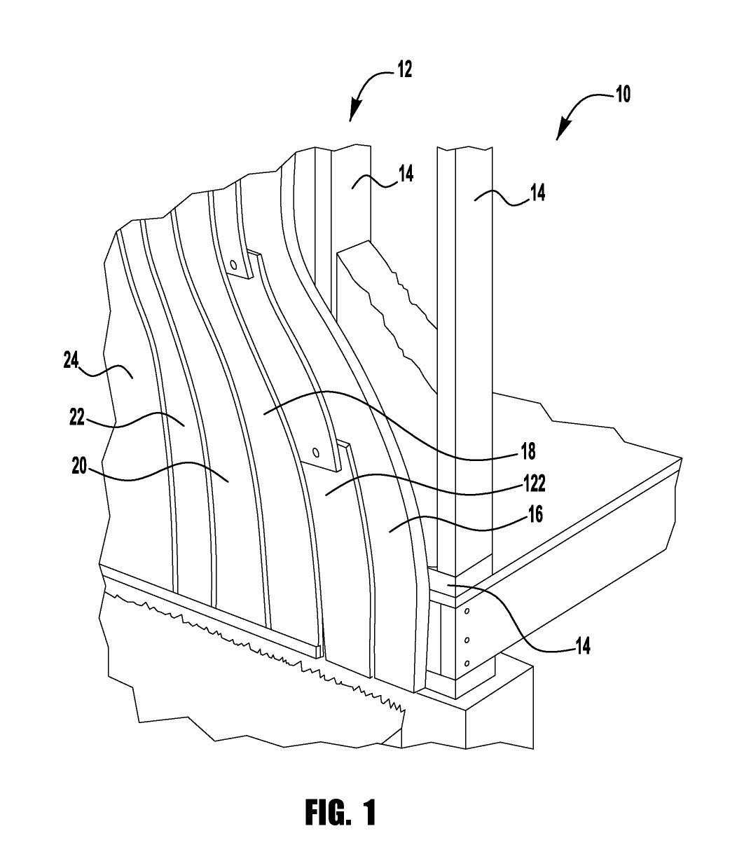

FIG. 1 illustrates an example of stucco applied to an external wall 12 of a building 10. The building includes frame members 14, such as 2×4 lumber members, that support sheathing 16, such as plywood or oriented strand board. The stucco 10 is reinforced with a wire mesh lath 18 to resist movement and resulting cracking. The wire mesh lath 18 is attached with nails or screws to the frame members 14 and sheathing 16. In the example illustrated by FIG. 1, a protective material 122 is provided between the wire mesh lath 18 and the sheathing 16. The protective material 122 protects the framing 14 and sheathing 16 from moisture damage. The protective material 122 may be a cement based primer, or a vapor-permeable, water-resistant weather barrier; typically an asphalt-saturated tar paper or one of a variety of manufactured plastic-based sheets, known as “housewrap” or “stucco wraps.”

A base or scratch coat 20 is applied to the wire mesh lath 18, such that when the base or scratch coat hardens, the lath becomes embedded into the base or scratch coat 20 to provide stiffening and adhesion of the stucco. The base or scratch coat 20 may be made of or otherwise comprise plastic cement and sand. A trowel is typically used to scratch the surface of the base or scratch coat 20 horizontally or in a crisscross pattern to provide a key for the second layer or brown coat 22. The base or scratch coat 20 is allowed to dry (cure) before the second layer or brown coat 22 is applied.

The second layer 22 is referred to as the brown coat or leveling coat. The brown coat may include sand, cement, and lime. The brown coat 22 is leveled with tools called “darbies,” “rods,” and “feathereges,” scraped smooth, and floated to provide a smooth, even surface onto which a finish coat 24 is applied. The brown coat 22 is allowed to dry (cure) before the finish coat 24 is applied.

The final, exterior layer of stucco is the finish coat 24. One type of finish coat is an acrylic finish coat. The acrylic finish coat is acrylic-based finish from 1 to 4 mm thick. The acrylic finish coat can be applied in many ways and can be ordered in many colors.

Another type of finish coat 24 is a color coat finish. The color coat finish includes a colored sand, cement, and lime mixed finish typically 3 mm thick. The color coat is applied over the brown coat 22 and can be floated with water for a sandy finish or textured over with a trowel to create various styles of finishes.

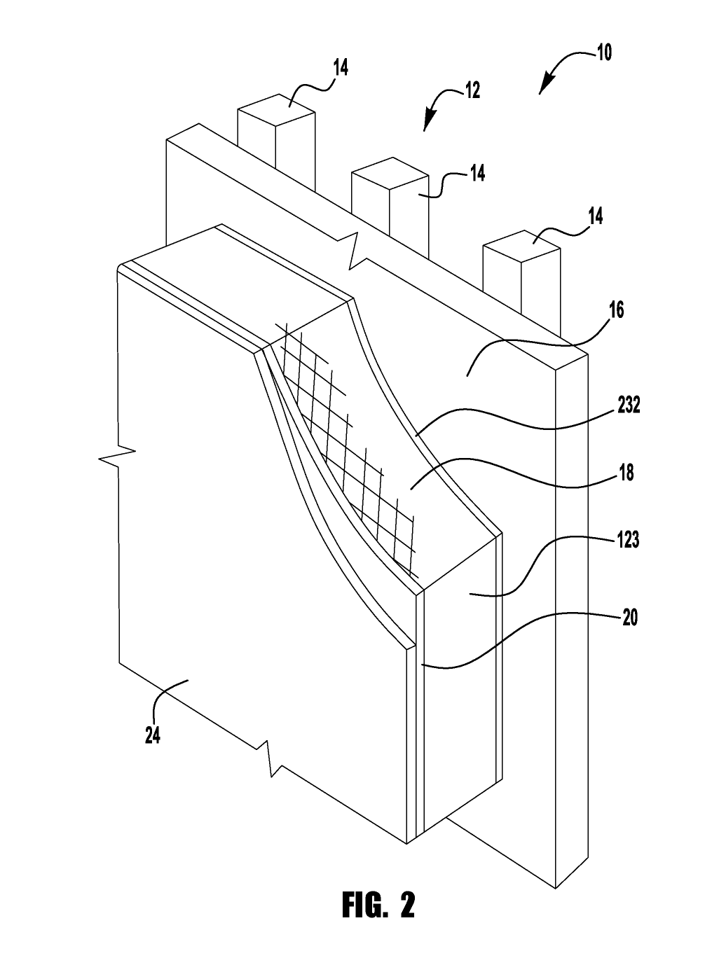

Referring to FIG. 2, a two-coat stucco is shown with one base layer 20 and a finish layer 24, which is thinner and faster to apply as compared to the traditional application of three-coat stucco. This two-layer system is often used on building walls that include an exterior foam insulation panel 230. FIG. 2 illustrates an example of stucco applied to an external wall 12 of a building 10 having an exterior foam insulation panel 230. The building 10 includes frame members 14, such as 2×4 lumber members, that support sheathing 16, such as plywood or oriented strand board. In the illustrated example, the exterior foam insulation panel 230 is secured to the sheathing 16 with an adhesive 232. In the example illustrated by FIG. 2, the stucco 10 is reinforced with a wire mesh lath 18 to resist movement and resulting cracking. The wire mesh lath 18 is attached to the foam insulation panel 230.

A base or scratch coat 20 is applied to the wire mesh lath 18, such that when the base or scratch coat 20 hardens, the lath 18 becomes embedded into the base or scratch coat 20 to provide stiffening and adhesion of the stucco. The base or scratch coat 20 is allowed to dry (cure) before the finish coat 24 is applied.

Reference is now made to FIG. 3 illustrating an exemplary embodiment of a stucco support structure 310. The stucco support structure 310 comprises a structural layer 312 of composite material formed from (a) a substantially homogeneous matrix of gypsum material and a polymer resin material and (b) wet-use chopped strand fibers, wherein the wet-use chopped strand fibers are substantially filamentized (i.e., substantially evenly separated and well-distributed) within the substantially homogeneous matrix. In addition, the stucco support structure 310 includes a stucco adhesion member (i.e., stucco adhesion layer or surface) 314 interfaced with the structural layer 312. For example, in certain embodiments, the stucco adhesion member 314 extends from a surface (e.g., a top or exterior facing surface) of the structural layer 312. In certain embodiments, the stucco adhesion member 314 is attached (e.g., via adhesives and/or mechanical fasteners) to a surface (e.g., a top or exterior facing surface) of the structural layer 312. In certain other embodiments, the stucco adhesion member 314 comprises one or more of grooves, undercuts, and undulations formed in the structural layer. The stucco adhesion member (i.e., stucco adhesion layer or surface) 314 eliminates the need for the lath 18 and/or one or more of the stucco coats (e.g., 20, 22).

The stucco adhesion layer or surface 314 may take substantially any appropriate form to perform the function(s) of the lath 18 and/or one or more of the stucco coats. In the embodiment of the stucco support structure 310 illustrated in FIG. 3, the stucco adhesion layer or surface 314 includes strands, filaments, fibers, and/or mesh that extend from the structural layer 312 and are configured to embed within stucco material, to bond the stucco material to the structural layer 312. A wide variety of different materials that include strands, filaments, fibers, and/or mesh can be used. For example, the stucco adhesion layer 314 may comprise fiberglass fibers, polymer fibers, entangled net material, and the like. The stucco adhesion layer 314 may comprise fibers that are formed into a non-woven material, such as a spunbond, air laid non-woven material. The stucco adhesion layer may comprise fibers that are woven, for example, woven into an open mesh material.

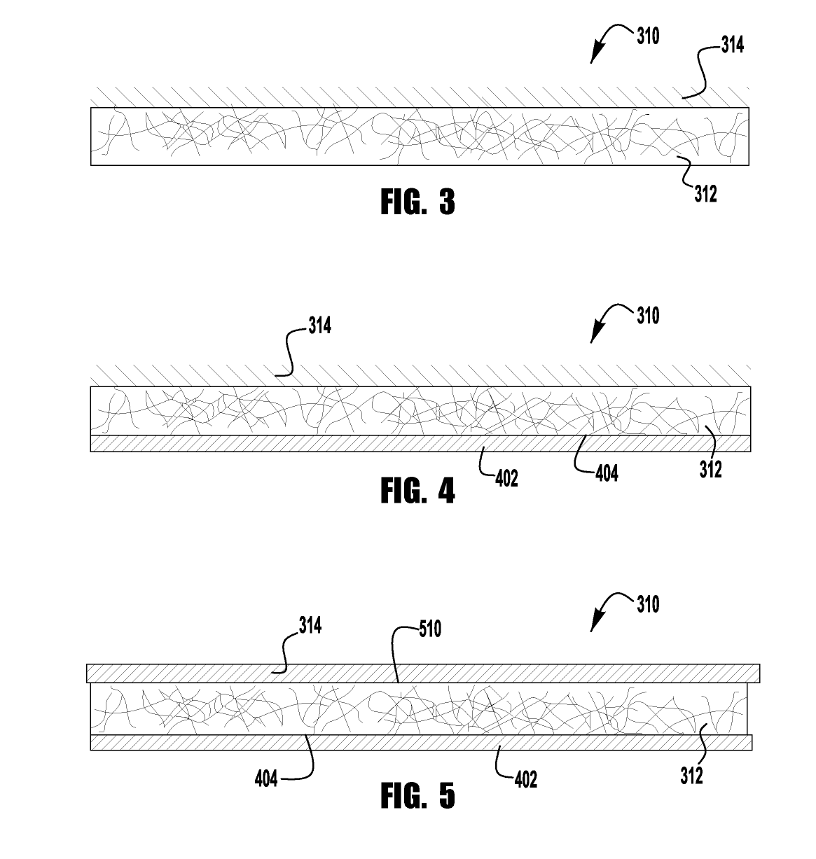

FIG. 4 is an embodiment of a stucco support structure 310 that is similar to the stucco support structure illustrated in FIG. 3, except the structural layer 312 is composite material formed from (a) a substantially homogeneous matrix of gypsum material and a polymer resin material, (b) wet-use chopped strand fibers, wherein the wet-use chopped strand fibers are substantially filamentized within the substantially homogeneous matrix, and (c) an optional additional reinforcement layer or mat 402 that the mixture of gypsum material, polymer resin, and wet-use chopped strand fibers are disposed upon and/or bound to. The additional reinforcement layer or mat 402 can take a wide variety of different forms. The additional reinforcement layer or mat 402 can include additional reinforcing strands, filaments, fibers, and/or mesh that reinforce the inner (interior facing) surface 404 of the structural layer 312. A wide variety of different materials that include strands, filaments, fibers, and/or mesh can be used. For example, the additional reinforcement layer or mat 402 may comprise fiberglass fibers, polymer fibers, entangled net material, and the like. The additional reinforcement layer or mat 402 may be fibers that are applied directly to the material of the structural layer 312, an unbonded non-woven mat, a non-woven mat that is held together with a binder, an unbonded woven mat, and a woven mat that is held together with a binder. In one exemplary embodiment, the additional reinforcement layer or mat 402 further prevents cracking of the structural layer 312 when the stucco support structure 310 is nailed to a frame member 14 using a standard framing or construction nail with a standard framing or construction pneumatic nail gun that is set to drive the head of the nail into engagement with the stucco support structure 310.

FIG. 5 is an embodiment of a stucco support structure 310 that is similar to the stucco support structure 310 illustrated in FIG. 4, except the stucco adhesion layer 314 is configured to both bond with a layer of stucco material and reinforce the outer (exterior facing) surface 510 of the structural layer 312. The stucco adhesion layer 314 can take a wide variety of different forms. The stucco adhesion layer 314 can include reinforcing strands, filaments, fibers, and/or mesh that reinforce the surface 510 of the structural layer 312 and provide a rough or otherwise textured surface for a layer of stucco material to bond with. A wide variety of different materials that include strands, filaments, fibers, and/or mesh can be used. For example, the stucco adhesion layer 314 may comprise fiberglass fibers, polymer fibers, entangled net material, and the like. The stucco adhesion layer 314 may be fibers that are applied directly to the material of the structural layer 312, an unbonded non-woven mat, a non-woven mat that is held together with a binder, an unbonded woven mat, and a woven mat that is held together with a binder. In one exemplary embodiment, a reinforcement material 402 prevents cracking of the inner (interior facing) surface 404 of the structural layer 312 when the stucco support structure 310 is nailed to a frame member 14 using a standard framing or construction nail with a standard framing or construction pneumatic nail gun that is set to drive the head of the nail into engagement with the stucco support structure 310.

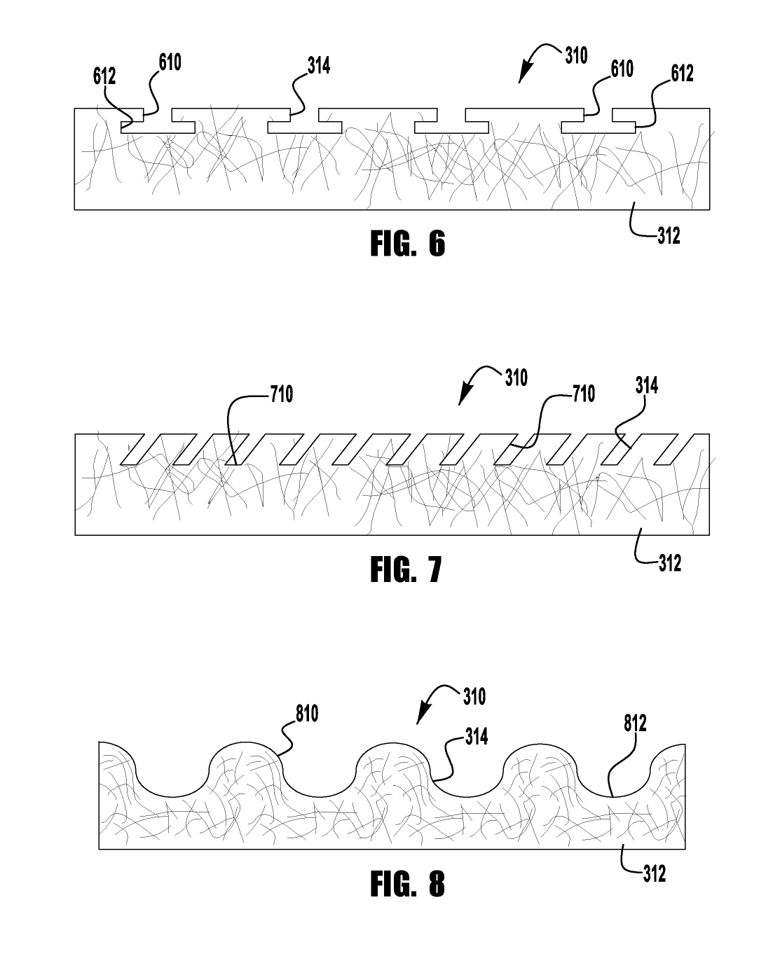

The stucco adhesion member 314 may take substantially any appropriate form to perform the function(s) of the lath 18 and/or one or more of the stucco coats. Referring to FIG. 6, in one exemplary embodiment, the stucco support structure 310 includes a stucco adhesion member 314 that eliminates the need for a stucco scratch coat 20. In the example illustrated by FIG. 6, the stucco adhesion member 314 comprises grooves 610 with undercuts 612 formed in the structural layer 312. A stucco brown coat 22 may extend into the grooves 610 and undercuts 612 to adhere the brown coat 22 directly to the stucco support structure 310, eliminating the need for both the lath 18 and scratch coat 20. The grooves 610 can take a wide variety of different forms. Any configuration that allows bonding of the brown coat 22 directly to the stucco support structure 310 can be used. For example, FIG. 7 illustrates another example of a stucco support structure 310 that includes a stucco adhesion member 314 comprising undercut grooves 710 formed in the structural layer 312. The grooves 710 illustrated by FIG. 7 can be easily formed in the stucco support structure 310 with a saw blade or saw blades that are oriented at an angle θ or an extrusion die. The grooves 710 may be parallel and/or form a crossing pattern.

FIG. 8 illustrates another exemplary embodiment of a stucco adhesion member 314 that performs the function(s) of the lath 18 and/or one or more of the stucco coats. Referring to FIG. 8, in one exemplary embodiment, the stucco support structure 310 includes a stucco adhesion member 314 that eliminates the need for a stucco scratch coat 20. In the example illustrated by FIG. 8, the stucco adhesion member 314 comprises an undulating surface 810 formed in the structural layer 312. A stucco brown coat 22 may extend into the valleys 812 of the undulating surface 810 to adhere the brown coat 22 directly to the stucco support structure 310, eliminating the need for both the lath 18 and scratch coat 20. The valleys 812 can take a wide variety of different forms. Any configuration that allows bonding of the brown coat 22 directly to the stucco support structure 310 can be used. The valleys 812 illustrated by FIG. 8 can be formed in the stucco support structure 310 by an extrusion die and/or with a roller or rollers that press on the stucco support structure 310 as it is formed.

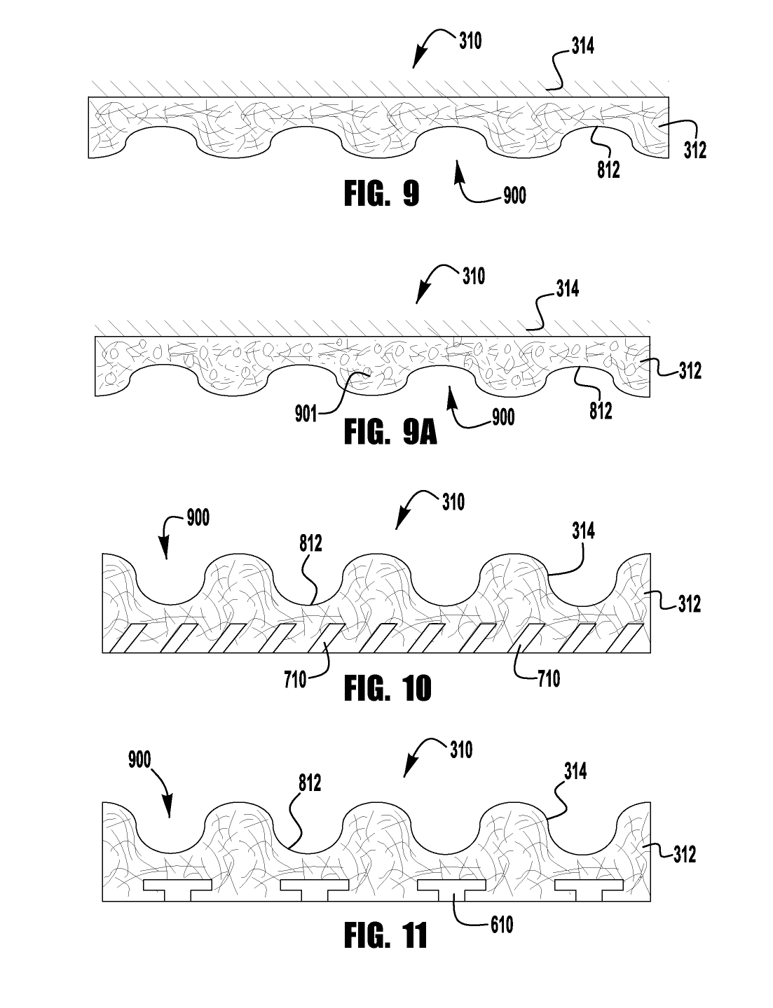

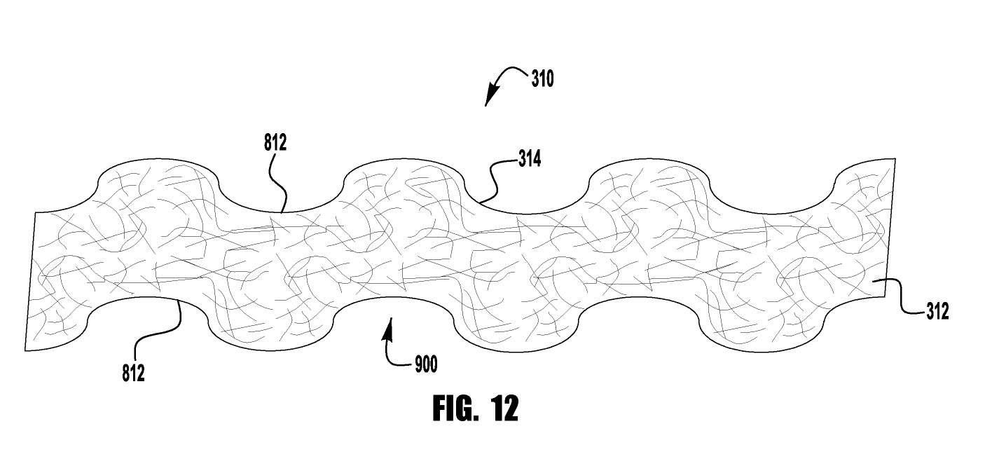

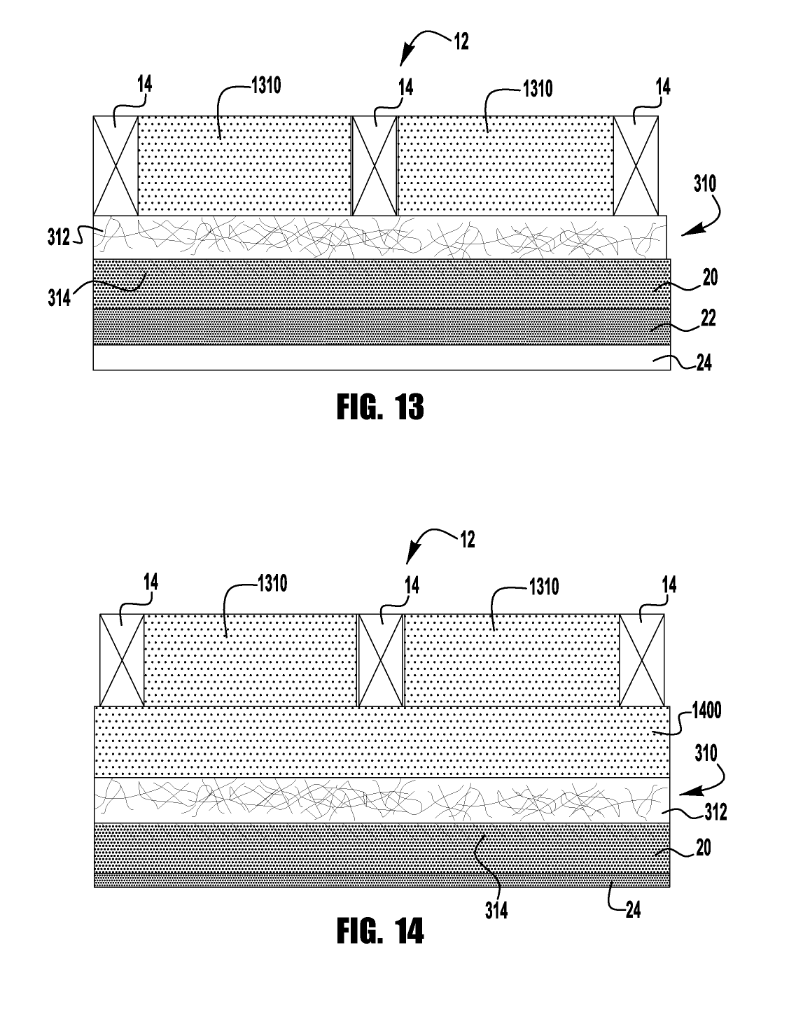

Referring to FIGS. 9-12, in some exemplary embodiments, the stucco support structure 310 is configured to provide a drainage path(s) 900. The drainage path(s) 900 allow moisture that may become trapped between layers of the wall system to drain out of the wall system through the drainage paths 900. The drainage paths 900 can take a wide variety of different forms. In the example illustrated by FIG. 9, the drainage paths 900 may be formed by valleys 812 of undulations and/or the stucco support structure 310 or a portion of the stucco support structure 310. When the stucco support structure 310 or a portion of the stucco support structure 310 is porous enough (See pores 901 in FIG. 9A for example) to provide a drainage path, the additional drainage features, such as the valleys 812 may be omitted. In the example illustrated by FIG. 10, the drainage paths 900 may be formed by valleys 812 of undulations, grooves 710, and/or the stucco support structure 310 or a portion of the stucco support structure 310. In the example illustrated by FIG. 11, the drainage paths 900 may be formed by valleys 812 of undulations, grooves 610, and/or the stucco support structure 310 or a portion of the stucco support structure 310. In the example illustrated by FIG. 12, the drainage paths 900 may be formed by valleys 812 of either of the undulating surfaces, and/or the stucco support structure 310 or a portion of the stucco support structure 310.

FIG. 13 illustrates an exemplary embodiment of a stucco wall 12 that uses any of the stucco support structures 310 described herein. In the example illustrated by FIG. 13, the building includes frame members 14, such as 2×4 lumber members, that support stucco support structures 310. The stucco support structures 310 can be attached to the frame members 14 in a wide variety of different ways. For example, the stucco support structures 310 can be attached to the frame members 14 by nailing. The illustrated stucco support structures 310 are the stucco support structures 310 illustrated by FIG. 3, but the stucco support structures 310 can be any of the stucco support structures 310 disclosed herein or have any combination or subcombination of the stucco support structures 310 disclosed herein. In the illustrated embodiment, insulation 1310 is disposed between the frame members 14, to insulate the building wall. For example, the insulation 1310 may be fiberglass batt insulation, foam board insulation, spray foam insulation, or any other type of insulation. In the example illustrated by FIG. 13, the stucco support structure 310 eliminates the need for the sheathing 16 and the wire mesh lath 18.

A base or scratch coat 20 is applied to the stucco adhesion member (i.e., stucco adhesion layer or surface) 314, such that when the base or scratch coat hardens, the stucco adhesion layer or surface 314 becomes embedded into the base or scratch coat 20 to provide stiffening and adhesion of the stucco. The base or scratch coat 20 may be made of or otherwise comprise plastic cement and sand. A trowel is typically used to scratch the surface of the base or scratch coat 20 horizontally or in a crisscross pattern to provide a key for the second layer or brown coat 22. The base or scratch coat 20 is allowed to dry (cure) before the second layer or brown coat 22 is applied.

The second layer 22 is referred to as the brown coat or leveling coat. The brown coat may include sand, cement, and lime. The brown coat 22 is leveled with tools called “darbies,” “rods,” and “feathereges,” scraped smooth, and floated to provide a smooth, even surface onto which a finish coat 24 is applied. The brown coat 22 is allowed to dry (cure) before the finish coat 24 is applied.

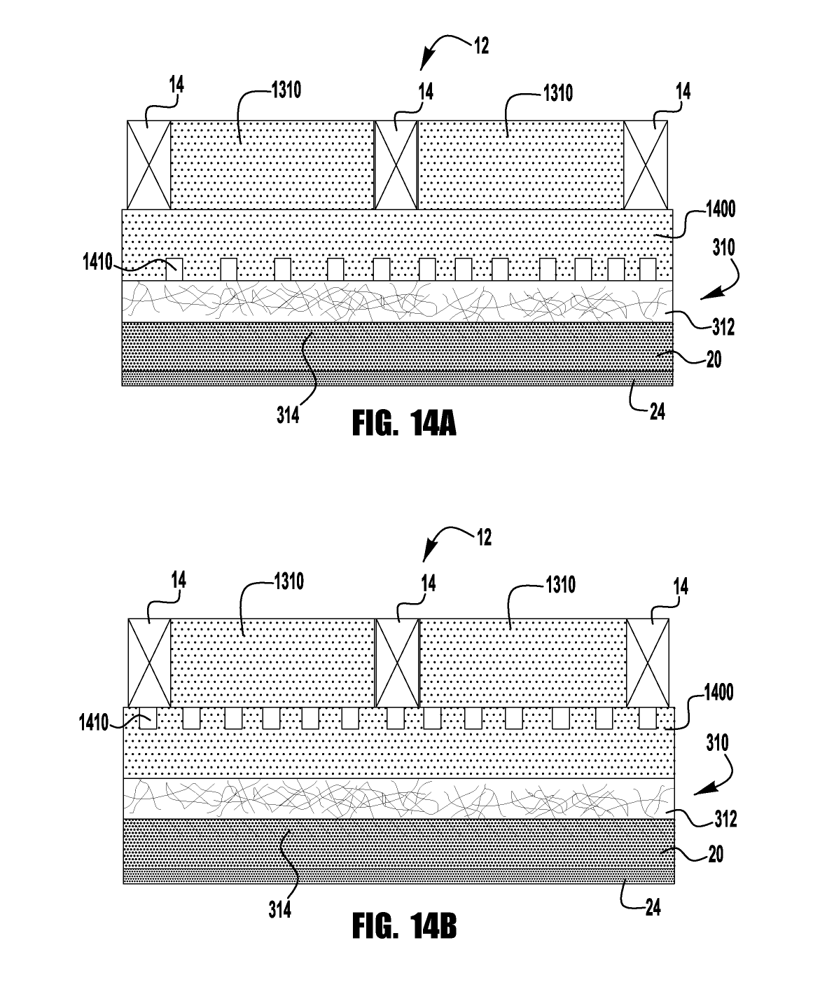

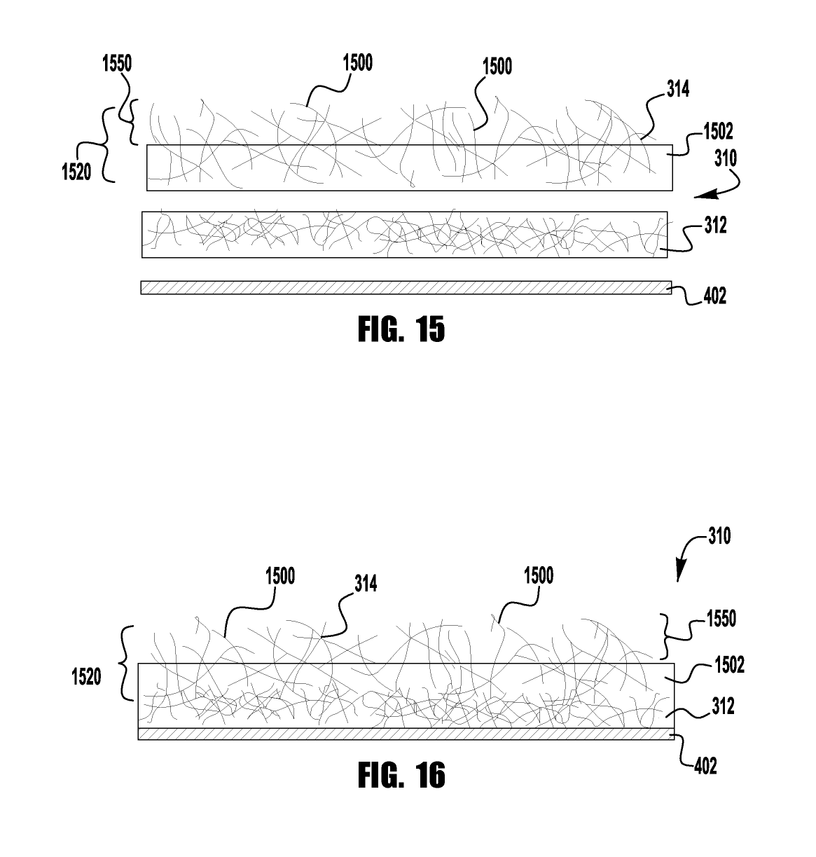

FIG. 14 illustrates an exemplary embodiment of a stucco wall 12 that uses any of the stucco support structures 310 described herein. In the example illustrated by FIG. 14, the building includes frame members 14, such as 2×4 lumber members, that support a foam panel 1400 and a stucco support structure 310. The foam panel 1400 can take a wide variety of different forms. The foam panel 1400 may be an open cell foam or a closed cell foam. The foam panel 1400 may be made from a wide variety of different polymer materials, including, but not limited to, polystyrene, polyurethane, and the like. The foam panel 1400 may be extruded or expanded polystyrene foam. The foam panel 1400 may be separate from the stucco support structure 310 (i.e., before attachment to the frame members 14) or the foam panel 1400 may be integral with the stucco support structure 310. When the foam panel 1400 is integral with the stucco support structure 310, the stucco support structure 310 may be secured to the foam panel 1400 by thermal bonding, by an adhesive, and/or by providing a mechanical interface between the stucco support structure 310 and the foam panel 1400, such as any of the mechanical interfaces disclosed in the present application between the stucco support structure 310 and the stucco.

FIGS. 14A and 14B illustrate exemplary embodiments where the foam panel 1400 includes drainage structures 1410. The drainage structures 1410 can take a wide variety of different forms. In the example illustrated by FIG. 14A, the drainage structures 1410 comprise channels that are cut or formed in the foam panel 1400 on the side that abuts the stucco support structure 310 to form a drainage plane for water. In the example illustrated by FIG. 14B, the drainage structures 1410 comprise channels that are cut or formed in the foam panel 1400 on the side that faces away from the stucco support structure 310 to form a drainage plane for water. In another exemplary embodiment, drainage structures 1410 may be formed on both sides of the foam panel 1400.

The stucco support structures 310 and the foam panel 1400 can be attached to the frame members 14 in a wide variety of different ways. For example, the stucco support structures 310 and the foam panels 1400 can be attached to the frame members 14 by nailing. The illustrated stucco support structures 310 are the stucco support structures 310 illustrated by FIG. 3, but the stucco support structures 310 can be any of the stucco support structures 310 disclosed herein or have any combination or subcombination of the stucco support structures 310 disclosed herein. In the illustrated embodiments of FIGS. 14, 14A, and 14B, insulation 1310 is disposed between the frame members 14, to insulate the building wall. For example, the insulation 1310 may be fiberglass batt insulation, foam board insulation, spray foam insulation or any other type of insulation. In the examples illustrated by FIGS. 14, 14A, and 14B, the stucco support structure 310 eliminates the need for the sheathing 16 and the wire mesh lath 18.

Referring again to FIG. 14, the stucco is reinforced with the stucco adhesion member (i.e., stucco adhesion layer or surface) 314 to resist movement and resulting cracking. A base or scratch coat 20 is applied to the stucco adhesion layer or surface 314, such that when the base or scratch coat 20 hardens, the stucco adhesion layer or surface 314 becomes embedded into the base or scratch coat 20 to provide stiffening and adhesion of the stucco. The base or scratch coat 20 may be made of or otherwise comprise plastic cement and sand. A trowel is typically used to scratch the surface of the base or scratch coat 20 horizontally or in a crisscross pattern to provide a key for the second layer or brown coat 22. The base or scratch coat 20 is allowed to dry (cure) before the second layer or brown coat 22 is applied. The second layer 22 is referred to as the brown coat or leveling coat. The brown coat may include sand, cement, and lime. The brown coat 22 is leveled with tools called “darbies,” “rods,” and “feathereges,” scraped smooth, and floated to provide a smooth, even surface onto which a finish coat 24 is applied. The brown coat 22 is allowed to dry (cure) before the finish coat 24 is applied.

FIGS. 15 and 16 illustrate another exemplary embodiment of a stucco support structure 310. In the example illustrated by FIGS. 15 and 16, the stucco support structure 310 comprises a structural layer 312 of composite material formed from (a) a substantially homogeneous matrix of gypsum material and a polymer resin material and (b) wet-use chopped strand fibers, wherein the wet-use chopped strand fibers are substantially filamentized within the substantially homogeneous matrix. In the example illustrated by FIGS. 15 and 16, the stucco adhesion layer 314 comprises fibers 1500 that are partially captured in a polymer material 1502 and partially extend from the polymer material 1502. The fibers 1500 can take a wide variety of different forms. For example, the fibers can be fiberglass fiber, polymer fibers, or any other type of fibers. In one exemplary embodiment, the fibers 1500 are formed into a porous layer 1520 made from thermoplastic polymers, such as polyester, polyethylene terephthalate (PET), polypropylene, and the like. For example, the fibers 1500 may be formed into a non-woven material, such as a spunbond, air laid non-woven material or the fibers 1500 may be woven into an open mesh material. In one exemplary embodiment, the porous layer 1520 is made from a fine fiber PET material, such as a 2 denier fiber size PET material. The porous layer 1520 may be formed with a variety of different densities and lofts, which can be selected to adjust the adhesion between the stucco and the porous layer 1520. In one exemplary embodiment, the porous layer 1520 has a density of 15-300 grams per square foot and a thickness of ⅛ inch to 3 inches. In other embodiments, the porous layer 1520 may have a thickness of ½ inch to 1½ inches. For example, the porous layer 1520 may be a PET material, such as VersaMat 2110 that has a density of 20-25 grams per square foot with a thickness of about ¾ inch; or the porous layer 1520 may be a PET material, such as VersaMat 2110 that has a density of 60-80 grams per square foot and a thickness of about 1½ inch. However, any combination of materials, lofts, and densities may be selected or changed to achieve different performance characteristics, such as adhesion between the fibers 1500 and the stucco and reinforcement of the stucco with the fibers 1500.

The polymer material 1502 may take a wide variety of different forms. In one exemplary embodiment, the polymer 1502 is the same as or is compatible with polymer material of the structural layer 312 and/or the polymer material of the fibers 1500. In the example illustrated by FIG. 15, about half the length of the fibers 1500 or half the thickness of the porous layer 1520 made from the fibers 1500 is disposed in the polymer material 1502. However, any length of fibers 1500 or portion of the thickness of a porous layer 1520 may be disposed in the polymer material 1502. The polymer material 1502 may be a solid material, a solid material with fillers, and/or a foamed material.

In the exemplary embodiment illustrated by FIGS. 15 and 16, the polymer material 1502 and attached fibers 1500 are provided on top of the structural layer 312. In an exemplary embodiment, the polymer material 1502 and the structural layer 312 are combined while polymeric material of each of the layers 312, 1502 is molten to bond the two layers together. In another exemplary embodiment, the layers 312, 1502 are attached together with an adhesive or by other means. The portion 1550 of the fibers 1500 or porous layer 1520 that extends from the polymeric material 1502 eliminates the need for the lath 18 and/or one or more of the stucco coats (e.g., 20, 22). In the example illustrated by FIGS. 15 and 16, the structural layer 312 includes an optional reinforcement layer or mat 402.

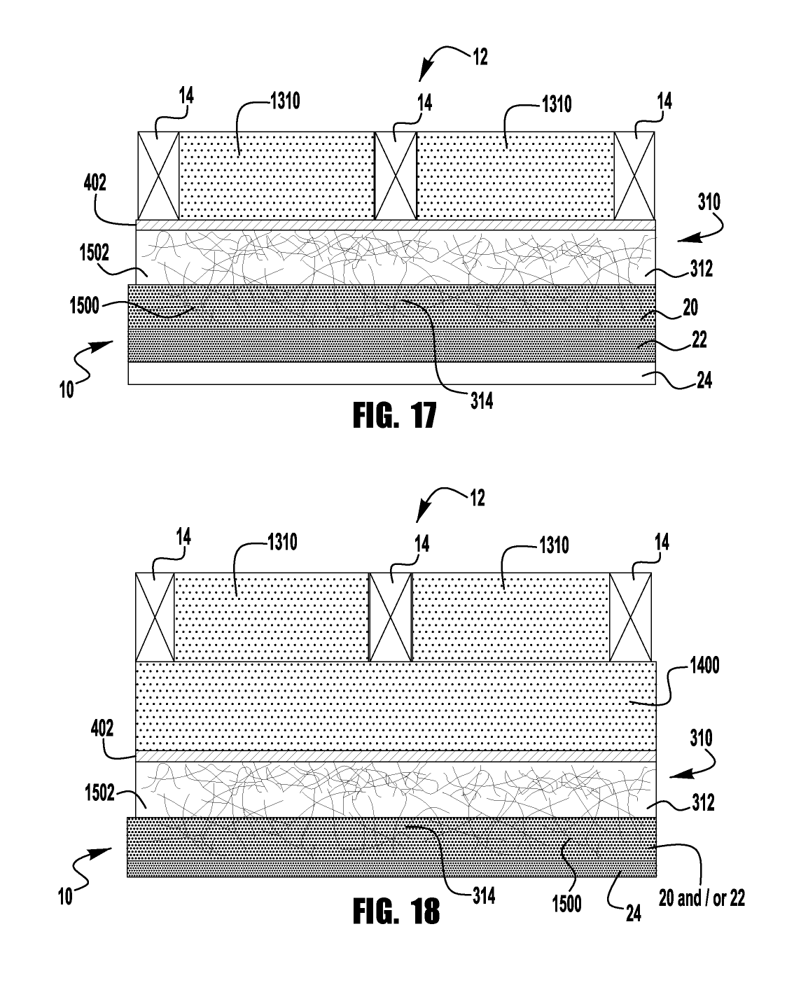

FIG. 17 illustrates an exemplary embodiment of a stucco wall 12 that uses the stucco support structure 310 shown in FIGS. 15 and 16. In the example illustrated by FIG. 17, the building 10 includes frame members 14, such as 2×4 lumber members, that support stucco support structures 310. The stucco support structures 310 can be attached to the frame members 14 in a wide variety of different ways. For example, the stucco support structures 310 can be attached to the frame members 14 by nailing. The illustrated stucco support structures 310 are the stucco support structures 310 illustrated by FIGS. 15 and 16. In the illustrated embodiment, insulation 1310 is disposed between the frame members 14, to insulate the building wall. For example, the insulation 1310 may be fiberglass batt insulation, foam board insulation, spray foam insulation or any other type of insulation. In the example illustrated by FIG. 17, the stucco support structure 310 eliminates the need for the sheathing 16 and the wire mesh lath 18.

The stucco is reinforced with the fibers 1500 of the stucco adhesion member (i.e., stucco adhesion layer or surface) 314 to resist movement and resulting cracking. A base or scratch coat 20 is applied to the fibers 1500 of the stucco adhesion member 314, such that when the base or scratch coat 20 hardens, the fibers 1500 become embedded into the base or scratch coat 20 to provide stiffening and adhesion of the stucco. The base or scratch coat 20 may be made of or otherwise comprise plastic cement and sand.

FIG. 18 illustrates an exemplary embodiment of a stucco wall 12 that uses any of the stucco support structures 310 shown in FIGS. 15 and 16. In the example illustrated by FIG. 18, the building 10 includes frame members 14, such as 2×4 lumber members, that support a foam panel 1400 and a stucco support structure 310. The foam panel 1400 can take a wide variety of different forms. The foam panel 1400 may be an open cell foam or a closed cell foam. The foam panel 1400 may be made from a wide variety of different polymer materials, including but not limited to, polystyrene, polyurethane, and the like. The foam panel 1400 may be extruded or expanded polystyrene foam. The foam panel 1400 may be separate from the stucco support structure 310 (i.e., before attachment to the frame members 14) or the foam panel 1400 may be integral with the stucco support structure 310. When the foam panel 1400 is integral with the stucco support structure 310, the stucco support structure 310 may be secured to the foam panel 1400 by thermal bonding, by an adhesive, and/or by providing a mechanical interface between the stucco support structure 310 and the foam panel 1400, such as any of the mechanical interfaces disclosed in the present application between the stucco support structure 310 and the stucco.

The stucco support structures 310 and the foam panels 1400 can be attached to the frame members 14 in a wide variety of different ways. For example, the stucco support structures 310 and the foam panels 1400 can be attached to the frame members 14 by nailing. The illustrated stucco support structures 310 are the stucco support structures 310 illustrated by FIGS. 15 and 16. In the illustrated embodiment of FIG. 18, insulation 1310 is disposed between the frame members 14, to insulate the building wall. For example, the insulation 1310 may be fiberglass batt insulation, foam board insulation, spray foam insulation or any other type of insulation.

In the example illustrated by FIG. 18, the stucco support structures 310 eliminate the need for the sheathing 16 and the wire mesh lath 18. The stucco is reinforced with the fibers 1500 of the stucco adhesion member (i.e., stucco adhesion layer or surface) 314 to resist movement and resulting cracking. A base or scratch coat 20 is applied to the fibers 1500 of the stucco adhesion member 314, such that when the base or scratch coat 20 hardens, the fibers 1500 of the stucco adhesion member 314 become embedded into the base or scratch coat 20 to provide stiffening and adhesion of the stucco. The base or scratch coat 20 may be made of or otherwise comprise plastic cement and sand. The base or scratch coat 20 is allowed to dry (cure) before the finish coat 24 is applied.

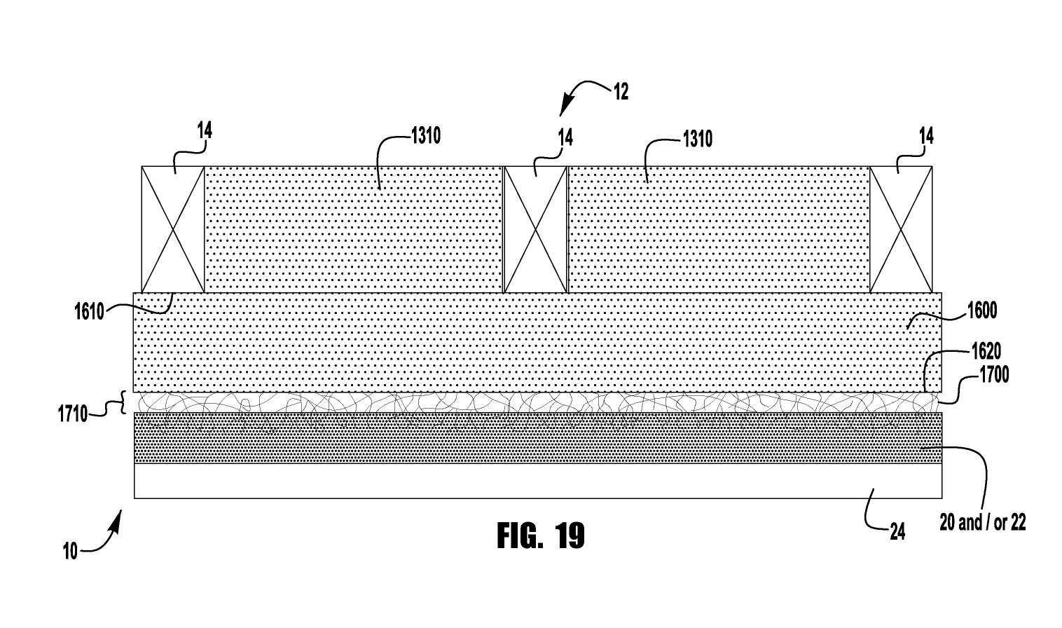

Referring now to FIG. 19, an alternative exemplary embodiment of a stucco wall 12 is shown. In the example illustrated by FIG. 19, the building 10 includes a plurality of frame members 14, such as 2×4 lumber members, that support a substrate 1600 having an interior facing surface 1610 and an exterior facing surface 1620 that is parallel to the interior facing surface 1610 and spaced therefrom to define a thickness of the substrate 1600. The substrate 1600 can take a variety of different forms and may comprise a variety of materials. In certain embodiments, the substrate 1600 is generally planar and may be formed so that the interior and exterior facing surfaces 1610, 1620 have a rectangular or square shape defined by a length of the surfaces 1610, 1620 and a width of the surfaces 1610, 1620. The substrate 1600 may have a range of thicknesses (measured from the interior facing surface 1610 to the exterior facing surface 1620). For example, the thickness of the substrate 1600 may be from 0.125 inches (3.175 mm) to 4.5 inches (114.3 mm). In certain embodiments, the substrate 1600 has a thickness from 0.75 inches (19.05 mm) to 4 inches (101.6 mm), including from 0.75 inches (19.05 mm) to 3.5 inches (88.9 mm), and also including from 1 inch (25.4 mm) to 3 inches (76.2 mm).

The interior and exterior facing surfaces 1610, 1620 of the substrate 1600 may have a variety of different lengths and widths. In certain embodiments, the length of the surfaces 1610, 1620 of the substrate 1600 may be from 48 inches (121.92 cm) to 108 inches (274.32 cm), and the width of the surfaces 1610, 1620 of the substrate 1600 may be from 12 inches (30.48 cm) to 60 inches (152.4 cm). In certain embodiments, the surfaces 1610, 1620 of the substrate 1600 have a length from 48 inches (121.92 cm) to 96 inches (243.84 cm) and a width from 16 inches (40.64 cm) to 48 inches (121.92 cm).

A variety of materials may be used as the substrate 1600. The particular material used as the substrate 1600 may depend on factors such as climate and building codes, just to name a couple. Exemplary materials suitable for use as the substrate 1600 include, but are not limited to, rigid insulation board, composite material, oriented strand board, plywood, fiberboard, and cement board. In certain embodiments, the substrate 1600 comprises a rigid insulation board. In certain embodiments, the rigid insulation board may be an extruded polystyrene foam board, an expanded polystyrene foam board, or a polyisocyanurate foam board.

In certain exemplary embodiments, the substrate 1600 comprises a composite material. The composite material may comprise (a) a substantially homogeneous matrix of gypsum material and a polymer resin material and (b) wet-use chopped strand fibers, wherein the wet-use chopped strand fibers are substantially filamentized (i.e., substantially evenly separated and well-distributed) within the substantially homogeneous matrix.

In certain exemplary embodiments, the substrate 1600 comprises a combination of a rigid insulation board and a composite material. For example, the substrate 1600 may comprise a rigid insulation board that is attached to a composite material. The attachment of the rigid insulation board to the composite material may be accomplished by any conventional means known to one of skill in the art such as, for example, thermal bonding, adhesives, mechanical fasteners, and/or by providing a mechanical interface between the rigid insulation board and the composite material.

The substrate 1600 can be attached to the frame members 14 in a variety of different ways. For example, the substrate 1600 can be attached to the frame members 14 by nailing. In the illustrated embodiment of FIG. 19, insulation 1310 is disposed between the frame members 14, to insulate the building wall. For example, the insulation 1310 may be fiberglass batt insulation, foam board insulation, spray foam insulation, or any other type of insulation.

With continued reference to FIG. 19, the stucco wall 12 also includes an entangled net material 1700 extending from the exterior facing surface 1620 of the substrate 1600. The entangled net material 1700 is a three-dimensional, mesh-like, open-structured body (e.g., mat) comprising monofilament yarns of material bonded together at various intersecting points. The entangled net material 1700 may be formed from a variety of materials. Preferably the entangled net material 1700 comprises a polymer material. In certain exemplary embodiments, the entangled net material 1700 comprises a polymer selected from the group consisting of polyamides, polyolefins, polyesters, polyimides, polytetrafluoroethylene, polystyrene, polyvinylchloride, and combinations thereof. The entangled net material 1700 may be formed by extrusion of a melted polymer through articulated spinnerets. An exemplary entangled net material 1700 is commercially available from Low & Bonar, PLC (Enka, N.C.).

The entangled net material 1700 may have a range of thicknesses. For example, the thickness of the entangled net material 1700 may be from 0.0625 inches (1.59 mm) to 2 inches (50.8 mm). In certain embodiments, the entangled net material 1700 has a thickness from 0.125 inches (3.175 mm) to 1 inch (25.4 mm), including from 0.25 inches (6.35 mm) to 0.75 inches (19.05 mm), and also including from 0.25 inches (6.35 mm) to 0.5 inches (12.7 mm). The length and width of the entangled net material 1700 are preferably configured to correspond to the length and the width of the surfaces 1610, 1620 of the substrate 1600. The entangled net material 1700 may be formed to have an open structure of at least 80%, including at least 85%, at least 90%, and also including an open structure of at least 95%.

In certain exemplary embodiments, the entangled net material 1700 is attached to the exterior facing surface 1620 of the substrate 1600 with an adhesive. Any adhesive that is capable of securing the entangled net material 1700 to the exterior facing surface 1620 of the substrate 1600 may be used. Exemplary adhesives that may be used include, but are not limited to, polyvinyl acetate-based adhesives, epoxy-based adhesives, polyurethane-based adhesives, cyanoacrylate-based adhesives, acrylic-based adhesives, and rubber cement. In certain other embodiments, the entangled net material 1700 may be attached to the exterior facing surface 1620 of the substrate 1600 with mechanical fasteners such as, for example, staples.

In certain exemplary embodiments, the entangled net material 1700 is integrally formed with the exterior facing surface 1620 of the substrate 1600. For example, a portion of the entangled net material 1700 may be partially embedded within the exterior facing surface 1620 of the substrate 1600 when the substrate 1600 is formed. As one example, the substrate 1600 may be formed from a composite material and the entangled net material 1700 is partially embedded within the composite material before the composite material cures or sets.

In certain exemplary embodiments, the stucco wall 12 includes a substrate 1600 comprising an extruded polystyrene board, and an entangled net material 1700 comprising a polymer, wherein the entangled net material 1700 is attached to the exterior facing surface 1620 of the extruded polystyrene board with an adhesive. In certain other exemplary embodiments, the stucco wall 12 includes a substrate 1600 comprising an extruded polystyrene board, and an entangled net material 1700 comprising a polymer, and the entangled net material 1700 is partially embedded in the exterior facing surface 1620 of the extruded polystyrene board.

As seen in the embodiment illustrated in FIG. 19, the stucco wall 12 also includes at least one stucco coat on the entangled net material 1700. The combination of the substrate 1600 and the entangled net material 1700 provide enhanced support for one or more coating layers applied thereto (e.g., any of stucco coatings 20, 22, and/or 24) to prevent or reducing cracking of the coating due to forces caused by thermal expansion or contraction or other forces that may result in displacement. The stucco coat may comprise one or more of a base or scratch coat 20, a brown coat 22, and a finish coat 24, as previously described herein. In certain embodiments, the stucco coat consists of a finish coat 24. The stucco coat is applied on the entangled net material 1700 such that the stucco coat partially extends through a portion of a thickness of the entangled net material 1700 to define a compliance zone 1710. The compliance zone 1710 comprises the entangled net material 1700 that extends from the exterior facing surface 1620 of the substrate 1600 and is free of the stucco coat. Due to the configuration and materials comprising the entangled net material 1700, the compliance zone 1710 functions to absorb forces (e.g., stresses, strains) caused by thermal expansion or contraction or other forces that may result in displacement. In other words, the stucco coat floats with respect to the structural members of the wall that are susceptible to expansion, contraction, or other displacement. In addition to absorbing forces, the compliance zone 1710 may also function as a drainage path due to the open-structured body of the entangled net material 1700. A stucco wall 12 having such a compliance zone 1710 may reduce or prevent cracking of the stucco coat, which can reduce or even eliminate the costs associated with repairing or replacing the stucco wall 12.

In the embodiment illustrated in FIG. 19, the substrate 1600 and entangled net material 1700 eliminate the need for the sheathing 16 and the wire mesh lath 18. Providing a substrate 1600 formed with an entangled net material 1700 extending therefrom also reduces labor time and costs associated with constructing stucco walls 12. For example, construction of conventional stucco walls typically requires the application of four separate layers of materials for three-coat stucco systems (i.e., wire mesh lath, base coat, brown coat, and finish coat), and three separate layers of materials for one-coat stucco systems (i.e., expanded polystyrene (EPS) foam and wire mesh lath, base coat, and finish coat). The substrate 1600 with entangled net material 1700 can be used to replace the wire mesh lath layer (for three-coat stucco systems), the EPS foam and wire mesh lath layer (for one-coat stucco systems), the base coat, and optionally the brown coat (for three-coat stucco systems), which results in at least one less layer of material to apply in the construction process.

In any of the embodiments, the composite material that forms the structural layer 312 can include a gypsum material component that absorbs water, adds strength, is a low-cost filler, and provides fire resistance. The gypsum material is generally defined as a hydrous calcium sulfate material and can be, for example, one or more alpha, beta, or synthetic gypsums.

The composite material that forms the structural layer 312 can also include a polymer component that provides water resistance, strength, and readily bonds to the wet-use chopped strand fibers. It is understood that in certain embodiments the polymer can be a suitable non-styrene polymer and that in certain embodiments the polymer comprises a urea-formaldehyde (UF) resin.

The composite material that forms the structural layer 312 also includes a wet-use chopped strand material component that provides the composite with the desired reinforcement, strength, stiffness, low creep, good impact, dimensional stability, nail/screw compatibility, and bonding-to-polymer properties.

In certain embodiments, the wet-use chopped strand fibers are glass fibers that are formed by drawing molten glass into filaments through a bushing or orifice plate and applying an aqueous sizing composition containing lubricants, coupling agents, and film-forming binder resins to the filaments. The sizing composition provides protection to the fibers from interfilament abrasion and promotes compatibility between the glass fibers and the matrix in which the glass fibers are to be used. After the sizing composition is applied, the wet fibers may be gathered into one or more strands, chopped, and collected. The chopped strands may contain hundreds or thousands of individual glass fibers. The collected chopped glass strands are then packaged in their wet condition as wet chopped fiber strands.

The wet-use chopped strand reinforcing fibers that are useful in the composite material may be any type of organic or inorganic fiber. In certain embodiments, it is desired that the wet-use chopped strand fibers provide good structural qualities as well as good acoustical and thermal properties to the composite material that forms the structural layer 312.

Non-limiting examples of suitable reinforcing fibers that may be used in the structural layer 312 and/or the stucco adhesion layer 314 in the composite material include reinforcement glass fibers, wool glass fibers, natural fibers, cellulosic fibers, metal fibers, ceramic fibers, mineral fibers, carbon fibers, graphite fibers, nanofibers, or combinations thereof. The term “natural fiber,” as used herein, refers to plant fibers extracted from any part of a plant, including, but not limited to, the stem, seeds, leaves, roots, or bast. In the composite material, the reinforcing fibers may have the same or different lengths, diameters, and/or denier. In one embodiment, the reinforcing fibers are glass fibers, although other fibers can be used.

The wet-use chopped strand reinforcing fibers can have any suitable length that allows for good dispersion in the composite while also providing the desired structural properties. Non-limiting examples of such lengths include approximately 1 to 100 mm, and in certain embodiments, 1 to 10 mm, and in still other embodiments 10 to 50 mm.

Additionally, in certain non-limiting examples, the wet-use chopped strand reinforcing fibers may have diameters from 8 to 25 microns, and, in certain embodiments, can have diameters from 12 to 18 microns. The wet-use chopped strand reinforcing fibers may have varying lengths, aspect ratios, and diameters relative to each other within the composite material.

The wet-use chopped strand reinforcing fibers may be present in an amount of from 1% to 25%, by weight, of the total composite material, and, in certain embodiments, are present in an amount of from 2% to 10%, by weight, such as approximately 9%. Also, in certain embodiments, the wet-use chopped strand fibers have a moisture content of from 5% to about 25%, and, in certain embodiments, can have a moisture content of from 10% to 20%.

When wet-use chopped strand glass fibers are used as the reinforcing fibers, the glass fiber strands may be easily opened and dispersed within the substantially homogeneous matrix. The use of the wet-use chopped strand fiber causes little generation of undesirable static electricity due to the moisture present on the glass fibers.

In forming the composite material, bales of the wet-use chopped strand reinforcing fibers may be filamentized by any type of suitable opening system, such as bale opening systems, which are common in the industry. The opening system serves both to decouple the loosely clustered strands of the wet-use chopped strands and to enhance the fiber-to-fiber contact. That is, when the wet-use chopped strand fibers are filamentized (i.e., substantially evenly separated and well-distributed) within the polymer and/or gypsum mixture, substantially all (or at least a majority) of the wet-use chopped strand fibers are in direct contact with the polymer and/or gypsum matrix.

In an alternate embodiment, the wet-use chopped strand fibrous material can be formed into an impregnable material comprised of the wet-use chopped strand fibrous materials. In such embodiments, the wet-use chopped strands are substantially uniformly impregnated with a homogeneous gypsum urea formaldehyde mixture, acrylic, or any other water-based binder system.

In certain embodiments, the present composite provides at least the advantage that there is no need to use any condensing system to remove water from the wet-use chopped strand fibers. In other particular embodiments, a suitable condensing system can be used to remove a desired amount of the free water (i.e., water that is external to the wet-use chopped strand reinforcing fibers). In certain of such embodiments, some or substantially all of the water can be removed by the condensing system. It should be noted that the phrase “substantially all of the water,” as it is used herein, is meant to denote that all or nearly all of the free water is removed. The condensing system may be any drying or water removal device. Non-limiting examples include an air dryer, an oven, rollers, a suction pump, a heated drum dryer, an infrared heating source, a hot air blower, or a microwave-emitting source.

In one non-limiting example, after the wet-use chopped strand reinforcing fibers have passed through the condensing system, the fibers may be passed through another opening system, such as a bale opener as described above, to further filamentize and separate the reinforcing fibers.

It is to be noted that during the formation of the wet-use chopped strand fibers, an aqueous sizing composition is applied to the fibers after they are drawn from the bushing. The sizing may be applied by application rollers or by spraying the sizing directly onto the fibers. Generally, the sizing composition protects the fibers from breakage during subsequent processing, helps to retard interfilament abrasion, and ensures the integrity of the strands of glass fibers, e.g., the interconnection of the glass filaments that form the strand or bundle of fibers. Thus, the wet-use chopped strand fibers have water entrapped within the strands themselves. These “wetted” wet-use chopped strand fibers are generally packaged together and then subsequently “opened or filamentized.” The presence of water between and among the individual fibers greatly improves the processability in formulating the composite material.

More specifically, as the wet-use chopped strand fibers are being dispersed into the substantially homogeneous matrices, the viscosity of the “matrix/fibers” composite material being formed increases. Simultaneously, the gypsum is able to be interspersed among individual wet-use chopped strand fibers, and is able to react with the water present on the wet-use chopped strand fibers. Also occurring simultaneously is the curing of the polymer resin that is present in the matrix. The use of the wet-use chopped strand fibers (with their short length and interspersed water therebetween) allows for the hydration of the gypsum as the gypsum sets and the resin material cures. The wet-use chopped strand fibers provide a balance between ease of dispersion of the fibers within the homogeneous matrix and the greater amount of fibers that can be incorporated into the composite material.

The composite material of the structural layer 312 may also include one or more additives. Non-limiting examples of some of these additives include: perlite or pumice as a density reducer, additional water to manage consistency and/or to help set the gypsum, a coupling agent such as a silane to improve bonding, a filler such as sand (which is a low cost filler and provides additional fire resistance), a gypsum accelerator to control the hardening rate such as aluminum sulfate, and a polymer curative, such as ammonium sulfate (which speeds the UF resin cure rate).

In certain particular embodiments, the composite material can further include one or more of: at least one catalyst for increasing a rate of cure of the polymer resin material, at least one catalyst for increasing hardness of the gypsum during cure, at least one additive for reducing the density of the composite material, and at least one additive for improving water resistance of the composite material.

Also, it is to be noted that the composite material formulation can be enhanced depending on the end-use applications, and that such factors which can be considered include, but are not limited to: type of gypsum; type of polymer; presence of fillers, density reducers, etc.; amount of water; consistency (i.e., ratio of gypsum to water), density, cost/lb; cost/volume; viscosity; open or cure time; and use of extenders such as calcium carbonate or sand. These factors can be considered in order to make the lowest cost material but with the required performance characteristics.

The structural layer 312 of the stucco support structure 310 may be formed by a relatively simple and efficient production method. That method includes the steps of: coating a mold with a polymer/gypsum composite liquid to form a gel coat layer, allowing the gel coat layer to at least partially set, and adding a layer of composite material to the mold over the gel coat layer. The composite material comprises (a) a substantially homogeneous matrix of gypsum material and a polymer resin material and (b) wet-use chopped strand fibers. The wet-use chopped strand fibers are substantially filamentized within the homogeneous matrix. In addition, the method includes the steps of allowing the gel coat layer and composite material layer to at least partially set, and then removing them from the mold. The method may also include the optional step of painting the product following its removal from the mold.

The following example is presented to further illustrate the present invention.

### Example

A molded structural layer can be made in accordance with the present invention. Initially a silicone or polyurethane mold was made to the selected size for the stucco support substrate. The structural layer mold can be coated with polymer/gypsum liquid in order to form a gel coat layer that prevents air bubbles and nonfills from appearing on the molded part surface. The polymer/gypsum liquid was made from the following formula:

| Ingredient | Amount |
|---|---|
| Alpha Gypsum | 300 g |
| VF-812 Acrylic Latex (available from Smooth-On, Inc., | 150 g |
| Macungie, Pennsylvania 18062) | |
| Water | 10 g |
| L-77 Wetting Agent (available from Momentive Performance | 0.1 g |
| Materials) | |

The polymer/gypsum liquid was brushed onto the surface of the silicone mold. The wetting agent in the formula helped wet the hydrophobic mold surface. The polymer/gypsum liquid was then allowed to set for one hour to form the gel coat layer.

Next, the composite material was prepared from the following formula:

| Ingredient | Amount |
|---|---|
| Alpha Gypsum | 1,039 g |
| Hexion 472 (UF Resin) (available from Hexion Specialty | 710 g |
| Chemicals) | |
| Ammonium Sulfate | 3 g |
| Water | 50 g |
| Aluminum Sulfate Solution (10%) | 10 g |
| Wet-use Chopped Strands (¼ inch in length) | 100 g |
| L-77 wetting agent (available from Momentive Performance | 0.4 g |
| Materials) | |

First the Hexion 472 resin, water, aluminum sulfate solution, and wetting agent were placed in a two gallon pail. The ammonium sulfate was combined with the gypsum and added to the liquid with stirring. The resulting mix was blended for a few minutes until blended.

Next, the wet-use chopped strand glass fibers were added to the mix and stirred with a spatula until the fibers were well dispersed. The thick mixture was then trawled onto the mold, spread around and rolled out with a two inch diameter serrated roller. The top of the mold was then covered with a piece of plastic sheet as a moisture barrier and the mold was allowed to set for four days. After setting, the mold was carefully pulled away and the molded structural layer was allowed to age for about 5 days.

The formulas utilized in this example are strictly for purposes of illustration. Other ingredients like beta gypsum or perlite (density reducer) could be used. In addition, other additives and fillers (like CaCO₃) could be added to modify performance. Two solidification processes occur with this system. One is the setting of the gypsum (the hydration reaction), and the second is the cross linking (curing) of the urea formaldehyde resin.

The foregoing description of various preferred embodiments of the present invention have been presented for purposes of illustration and description. It is not intended to be exhaustive or to limit the invention to the precise form disclosed. Obvious modifications or variations are possible in light of the above teachings. While the disclosed embodiments typically eliminate the need for a sheathing and a wire mesh lath, certain embodiments of the present invention could nonetheless be used with a sheathing and/or a wire mesh lath.

The embodiments were chosen and described to explain the general principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled. The drawings and preferred embodiments do not and are not intended to limit the ordinary meaning of the claims in their fair and broad interpretation in any way.

What is claimed is:

1. A structure for supporting a stucco material, the structure comprising:
a) a structural layer of composite material comprising:
i) a homogenous matrix of a gypsum material and a polymer resin material; and
ii) wet-use chopped strand fibers, wherein the wet-use chopped strand fibers are substantially filamentized within the homogenous matrix; and
b) a stucco adhesion member interfaced with the structural layer.

2. The structure of claim 1, further comprising a reinforcement layer disposed on a surface of the structural layer opposite the stucco adhesion member.

3. The structure of claim 1, wherein the stucco adhesion member extends from a surface of the structural layer, and wherein the stucco adhesion member comprises a stucco adhesion layer comprising at least one of strands, filaments, fibers, an unbonded woven mat, an unbonded non-woven mat, a mesh, an entangled net material, a non-woven mat held together with a binder, a woven mat held together with a binder, and combinations thereof.

4. The structure of claim 3, wherein the stucco adhesion layer comprises one or more of fiberglass fibers, polymer fibers, and an entangled net material.

5. The structure of claim 1, wherein the stucco adhesion member is attached to a surface of the structural layer, and wherein the stucco adhesion member comprises a stucco adhesion layer comprising at least one of strands, filaments, fibers, an unbonded woven mat, an unbonded non-woven mat, a mesh, an entangled net material, a non-woven mat held together with a binder, a woven mat held together with a binder, and combinations thereof.

6. The structure of claim 5, wherein the stucco adhesion layer comprises one or more of fiberglass fibers, polymer fibers, and an entangled net material.

7. The structure of claim 1, wherein the stucco adhesion member comprises one or more of grooves, undercuts, and undulations formed in the structural layer.

8. The structure of claim 1, wherein the stucco adhesion member is means for receiving and bonding the stucco material to the structural layer, wherein the structural layer eliminates the need for a sheathing, and wherein the stucco adhesion member eliminates the need for a wire mesh lath.

9. The structure of claim 1, further comprising a drainage path.

10. The structure of claim 9, wherein the drainage path comprises one or more of valleys of undulations formed in the structural layer, grooves formed in the structural layer, and pores formed in the structural layer.

11. A system for forming a stucco wall on a plurality of frame members, the system comprising:
a) a stucco support structure attached to the frame members, wherein the stucco support structure comprises:
i) a structural layer of composite material comprising:
1) a homogenous matrix of a gypsum material and a polymer resin material; and
2) wet-use chopped strand fibers, wherein the wet-use chopped strand fibers are substantially filamentized within the homogenous matrix; and
ii) a stucco adhesion member interfaced with the structural layer; and
b) at least one stucco coat applied to the stucco adhesion member;
wherein the stucco support structure eliminates the need for a sheathing and a wire mesh lath.

12. The system of claim 11, wherein the stucco adhesion member extends from a surface of the structural layer, and wherein the stucco adhesion member comprises a stucco adhesion layer comprising at least one of strands, filaments, fibers, an unbonded woven mat, an unbonded non-woven mat, a mesh, an entangled net material, a non-woven mat held together with a binder, a woven mat held together with a binder, and combinations thereof.

13. The system of claim 11, wherein the stucco adhesion member is attached to a surface of the structural layer, and wherein the stucco adhesion member comprises a stucco adhesion layer comprising at least one of strands, filaments, fibers, an unbonded woven mat, an unbonded non-woven mat, a mesh, an entangled net material, a non-woven mat held together with a binder, a woven mat held together with a binder, and combinations thereof.

14. The system of claim 11, wherein the stucco adhesion member comprises one or more of grooves, undercuts, and undulations formed in the structural layer.

15. The system of claim 11, further comprising a foam panel positioned between the stucco support structure and the frame members.

16. The system of claim 15, wherein the foam panel comprises one or more drainage structures in the foam panel configured to allow moisture to drain out of the stucco wall.

17. A system for forming a stucco wall on a plurality of frame members, the system comprising:
a) a substrate attached to the frame members, the substrate having an interior facing surface and an exterior facing surface;
b) an entangled net material extending from the exterior facing surface of the substrate; and
c) at least one stucco coat on the entangled net material;
wherein the at least one stucco coat partially extends through a portion of a thickness of the entangled net material to define a compliance zone comprised of the entangled net material extending from the exterior facing surface of the substrate and free of the at least one stucco coat; and
wherein the compliance zone absorbs forces to reduce or prevent cracking of the at least one stucco coat.

18. The system according to claim 17, wherein the substrate comprises one or more of: a rigid insulation board; a panel of composite material; oriented strand board; plywood; fiberboard; and cement board.

19. The system according to claim 17, wherein the entangled net material comprises a polymer selected from the group consisting of polyamides, polyolefins, polyesters, polyimides, polytetrafluoroethylene, polystyrene, polyvinylchloride, and combinations thereof.

20. The system according to claim 17, wherein the substrate comprises an extruded polystyrene board;
wherein the entangled net material comprises a polymer; and
wherein the entangled net material is attached to the exterior facing surface of the extruded polystyrene board with an adhesive.
